(19) United States
(12) Patent Application Publication
(10) Pub. No.: US 2020/0336747 A1
(43) Pub. Date: Oct. 22, 2020

(54) INTER PREDICTION MODE-BASED IMAGE PROCESSING METHOD AND DEVICE THEREFOR

(71) Applicant: LG Electronics Inc., Seoul (KR)

(72) Inventor: Jungdong SEO, Seoul (KR)

(21) Appl. No.: 16/757,631

(22) PCT Filed: Mar. 19, 2018
(86) PCT No.: PCT/KR2018/003184

§ 371 Date: Apr. 20, 2020

Related U.S. Application Data
(60) Provisional application No. 62/574,218, filed on Oct. 19, 2017.

(51) Int. Cl. H04N 19/176; H04N 19/105; H04N 19/61; H04N 19/172

(52) U.S. Cl. CPC H04N 19/176; H04N 19/172; H04N 19/61; H04N 19/105

(57) ABSTRACT

Disclosed are an inter prediction mode-based image processing method and a device therefor. Specifically, the inter prediction mode-based image processing method may comprise the steps of: extracting, from a bitstream received from an encoder, motion information used in the inter prediction of a current block; by using the motion information, determining an initial reference block of the current block; on the basis of the initial reference block, determining at least one additional reference block in a previously reconstructed region; and by using the initial reference block and the at least one additional reference block, generating a prediction block of the current block.

### TECHNICAL FIELD

The present disclosure relates to a method of processing a still image or a moving image and, more particularly, to a method of encoding/decoding a still image or a moving image based on an inter-prediction mode and an apparatus supporting the same.

### BACKGROUND ART

Compression encoding means a series of signal processing techniques for transmitting digitized information through a communication line or techniques for storing information in a form suitable for a storage medium. A medium, such as a picture, an image or audio, may be a target for compression encoding. Particularly, a technique for performing compression encoding on a picture is referred to as video image compression.

Next-generation video content is supposed to have characteristics of high spatial resolution, a high frame rate and high dimensionality of a scene representation. Processing such content will lead to a drastic increase in the memory storage, memory access rate and processing power.

Accordingly, it is necessary to efficiently design a coding tool for processing next-generation video content.

### DISCLOSURE

### Technical Problem

The present disclosure proposes a method of additionally selecting or searching for a reference block based on the similarity of blocks in performing motion estimation or motion compensation.

Furthermore, the present disclosure proposes a method of performing a prediction using an additional reference block based on the similarity of blocks other than a reference block specified by motion information.

Technical objects to be achieved in the present disclosure are not limited to the aforementioned technical objects, and other technical objects not described above may be evidently understood by a person having ordinary skill in the art to which the present disclosure pertains from the following description.

### Technical Solution

In an aspect of the present disclosure, a method of processing an image based on an inter prediction mode may include extracting motion information used for an inter prediction of a current block from a bitstream received from an encoder, determining an initial reference block of the current block using the motion information, determining one or more additional reference blocks within a previously reconstructed region based on the initial reference block, and generating a prediction block of the current block using the initial reference block and the one or more additional reference blocks.

Preferably, determining the one or more additional reference blocks may include searching the previously reconstructed region for the one or more additional reference blocks using a difference from the initial reference block.

Preferably, determining the one or more additional reference blocks may include determining, as the one or more additional reference blocks, a first block that minimizes a value calculated by adding absolute values of differences between pixels of the initial reference block and the first block or a value calculated by adding squares of the differences.

Preferably, determining the one or more additional reference blocks may further include selecting a reference picture, not including the initial reference block, among reference pictures in a prediction direction of a current picture. The one or more additional reference blocks may be determined within the selected reference picture.

Preferably, selecting the reference picture may include selecting a reference picture, having the closest picture order count (POC) distance from the current picture, among the reference pictures in the prediction direction of the current picture.

Preferably, determining the one or more additional reference blocks may include scaling a motion vector of the current block using a POC value of the current picture, a POC value of a reference picture including the initial reference block, and a POC value of the selected reference picture. The one or more additional reference blocks may be determined within a region specified by the scaled motion vector or a region neighboring the region specified by the scaled motion vector.

Preferably, searching for the one or more additional reference blocks may include configuring a search region within a reference picture of a current picture. The one or more additional reference blocks may be searched for within the search region.

Preferably, the search region may be configured as a region of a specific form based on the initial reference block.

Preferably, generating the prediction block of the current block may include generating the prediction block of the current block by averaging the initial reference block and the one or more additional reference blocks.

Preferably, generating the prediction block of the current block may include generating the prediction block of the current block by applying a weight to the initial reference block.

In another aspect of the present disclosure, an apparatus for processing an image based on an inter prediction mode may include a motion information extraction unit configured to extract motion information used for an inter prediction of a current block from a bitstream received from an encoder, an initial reference block determination unit configured to determine an initial reference block of the current block using the motion information, an additional reference block determination unit configured to determine one or more additional reference blocks within a previously reconstructed region based on the initial reference block, and a prediction block generation unit configured to generate a prediction block of the current block using the initial reference block and the one or more additional reference blocks.

### Advantageous Effects

According to an embodiment of the present disclosure, prediction performance can be improved by additionally selecting a reference block based on the similarity of blocks.

Furthermore, according to an embodiment of the present disclosure, a noise removal effect can be expected by generating a prediction block using several reference blocks, and cording efficiency can be efficiently enhanced in a common ultra-high resolution image including noise.

Technical effects which may be obtained in the present disclosure are not limited to the technical effects described above, and other technical effects not mentioned herein may be understood to those skilled in the art from the description below.

### DESCRIPTION OF DRAWINGS

The accompanying drawings, which are included herein as a part of the description to help understand of the present disclosure, provide embodiments of the present disclosure, and describe the technical features of the present disclosure along with the detailed description.

FIG. 1 is illustrates a schematic block diagram of an encoder in which the encoding of a still image or video signal is performed, as an embodiment to which the present disclosure is applied.

FIG. 2 illustrates a schematic block diagram of a decoder in which decoding of a still image or video signal is performed, as an embodiment to which the present disclosure is applied.

FIG. 3 is a diagram for describing a split structure of a coding unit that may be applied to the present disclosure.

FIG. 4 is a diagram for describing a prediction unit that may be applied to the present disclosure.

FIG. 5 is an embodiment to which the present disclosure may be applied and is a diagram illustrating the direction of inter-prediction.

FIG. 6 is an embodiment to which the present disclosure may be applied and illustrates integers for ¼ sample interpolation and a fraction sample locations.

FIG. 7 is an embodiment to which the present disclosure may be applied and illustrates the location of a spatial candidate.

FIG. 8 is an embodiment to which the present disclosure is applied and is a diagram illustrating an inter-prediction method.

FIG. 9 is an embodiment to which the present disclosure may be applied and is a diagram illustrating a motion compensation process.

FIG. 10 is an embodiment to which the present disclosure is applied, and is a flowchart illustrating a method of additionally deriving a reference block and performing an inter prediction.

FIG. 11 is an embodiment to which the present disclosure is applied, and is a diagram for describing a method of determining a search region for an additional reference block.

FIG. 12 is an embodiment to which the present disclosure is applied, and is a diagram for describing a method of determining a search region for an additional reference block.

FIG. 13 is an embodiment to which the present disclosure is applied, and is a diagram for describing a method of generating a prediction block using an additional reference block.

FIG. 14 is an embodiment to which the present disclosure is applied, and is a diagram for describing a method of generating a prediction block using an additional reference block.

FIG. 15 is an embodiment to which the present disclosure is applied, and is a flowchart illustrating an inter prediction method using an additional reference block.

FIG. 16 is an embodiment to which the present disclosure is applied, and is a flowchart illustrating a method of selecting an additional reference block based on similarity with a reference block specified by motion information.

FIG. 17 is an embodiment to which the present disclosure is applied, and is a diagram illustrating a motion compensation method using an additional reference block according to an inter prediction mode.

FIG. 18 is an embodiment to which the present disclosure is applied, and is a flowchart illustrating a method of selecting an additional reference block based on similarity with a reference block specified by motion information.

FIG. 19 is an embodiment to which the present disclosure is applied, and is a diagram illustrating an example of a method of configuring a search region for an additional reference block.

FIG. 20 is a diagram illustrating an inter-prediction unit according to an embodiment of the present disclosure.

### MODE FOR INVENTION

Hereinafter, a preferred embodiment of the present disclosure will be described by reference to the accompanying drawings. The description that will be described below with the accompanying drawings is to describe exemplary embodiments of the present disclosure, and is not intended to describe the only embodiment in which the present disclosure may be implemented. The description below includes particular details in order to provide perfect understanding of the present disclosure. However, it is understood that the present disclosure may be embodied without the particular details to those skilled in the art.

In some cases, in order to prevent the technical concept of the present disclosure from being unclear, structures or devices which are publicly known may be omitted, or may be depicted as a block diagram centering on the core functions of the structures or the devices.

Further, although general terms widely used currently are selected as the terms in the present disclosure as much as possible, a term that is arbitrarily selected by the applicant is used in a specific case. Since the meaning of the term will be clearly described in the corresponding part of the description in such a case, it is understood that the present disclosure will not be simply interpreted by the terms only used in the description of the present disclosure, but the meaning of the terms should be figured out.

Specific terminologies used in the description below may be provided to help the understanding of the present disclosure. Furthermore, the specific terminology may be modified into other forms within the scope of the technical concept of the present disclosure. For example, a signal, data, a sample, a picture, a frame, a block, etc may be properly replaced and interpreted in each coding process.

Hereinafter, in this specification, a “processing unit” means a unit in which an encoding/decoding processing process, such as a prediction, a transform and/or quantization, is performed. Hereinafter, for convenience of description, a processing unit may also be called “processing block” or “block.”

A processing unit may be construed as having a meaning including a unit for a luma component and a unit for a chroma component. For example, a processing unit may correspond to a coding tree unit (CTU), a coding unit (CU), a prediction unit (PU) or a transform unit (TU).

Furthermore, a processing unit may be construed as being a unit for a luma component or a unit for a chroma component. For example, the processing unit may correspond to a coding tree block (CTB), coding block (CB), prediction block (PB) or transform block (TB) for a luma component. Alternatively, a processing unit may correspond to a coding tree block (CTB), coding block (CB), prediction block (PU) or transform block (TB) for a chroma component. Also, the present disclosure is not limited to this, and the processing unit may be interpreted to include a unit for the luma component and a unit for the chroma component.

Furthermore, a processing unit is not essentially limited to a square block and may be constructed in a polygon form having three or more vertices.

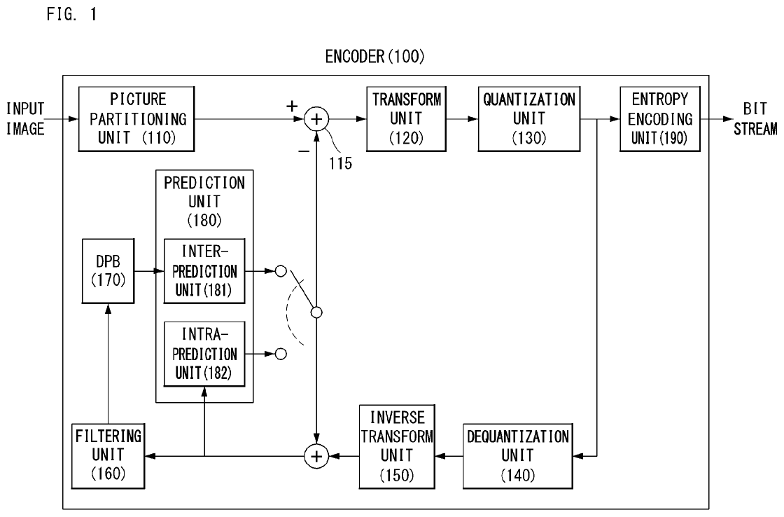

FIG. 1 is illustrates a schematic block diagram of an encoder in which the encoding of a still image or video signal is performed, as an embodiment to which the present disclosure is applied.

Referring to FIG. 1, the encoder 100 may include a video split unit 110, a subtractor 115, a transform unit 120, a quantization unit 130, a dequantization unit 140, an inverse transform unit 150, a filtering unit 160, a decoded picture buffer (DPB) 170, a prediction unit 180 and an entropy encoding unit 190. Furthermore, the prediction unit 180 may include an inter-prediction unit 181 and an intra-prediction unit 182.

The video split unit 110 splits an input video signal (or picture or frame), input to the encoder 100, into one or more processing units.

The subtractor 115 generates a residual signal (or residual block) by subtracting a prediction signal (or prediction block), output by the prediction unit 180 (i.e., by the inter-prediction unit 181 or the intra-prediction unit 182), from the input video signal. The generated residual signal (or residual block) is transmitted to the transform unit 120.

The transform unit 120 generates transform coefficients by applying a transform scheme (e.g., discrete cosine transform (DCT), discrete sine transform (DST), graph-based transform (GBT) or Karhunen-Loeve transform (KLT)) to the residual signal (or residual block). In this case, the transform unit 120 may generate transform coefficients by performing transform using a prediction mode applied to the residual block and a transform scheme determined based on the size of the residual block.

The quantization unit 130 quantizes the transform coefficient and transmits it to the entropy encoding unit 190, and the entropy encoding unit 190 performs an entropy coding operation of the quantized signal and outputs it as a bit stream.

Meanwhile, the quantized signal outputted by the quantization unit 130 may be used to generate a prediction signal. For example, a residual signal may be reconstructed by applying dequantization and inverse transformation to the quantized signal through the dequantization unit 140 and the inverse transform unit 150. A reconstructed signal may be generated by adding the reconstructed residual signal to the prediction signal output by the inter-prediction unit 181 or the intra-prediction unit 182.

Meanwhile, during such a compression process, neighbor blocks are quantized by different quantization parameters. Accordingly, an artifact in which a block boundary is shown may occur. Such a phenomenon is referred to a blocking artifact, which is one of important factors for evaluating image quality. In order to decrease such an artifact, a filtering process may be performed. Through such a filtering process, the blocking artifact is removed and the error of a current picture is decreased at the same time, thereby improving image quality.

The filtering unit 160 applies filtering to the reconstructed signal, and outputs it through a playback device or transmits it to the decoded picture buffer 170. The filtered signal transmitted to the decoded picture buffer 170 may be used as a reference picture in the inter-prediction unit 181. As described above, an encoding rate as well as image quality can be improved using the filtered picture as a reference picture in an inter-picture prediction mode.

The decoded picture buffer 170 may store the filtered picture in order to use it as a reference picture in the inter-prediction unit 181.

The inter-prediction unit 181 performs temporal prediction and/or spatial prediction with reference to the reconstructed picture in order to remove temporal redundancy and/or spatial redundancy.

In this case, a blocking artifact or ringing artifact may occur because a reference picture used to perform prediction is a transformed signal that experiences quantization or dequantization in a block unit when the reference picture is previously encoded/decoded.

Accordingly, in order to solve performance degradation attributable to the discontinuity of such a signal or quantization, signals between pixels may be interpolated in a sub-pixel unit by applying a low pass filter to the inter-prediction unit 181. In this case, the sub-pixel means a virtual pixel generated by applying an interpolation filter, and an integer pixel means an actual pixel that is present in a reconstructed picture. A linear interpolation, a bi-linear interpolation, a wiener filter, and the like may be applied as an interpolation method.

The interpolation filter may be applied to the reconstructed picture, and may improve the accuracy of prediction. For example, the inter-prediction unit 181 may perform prediction by generating an interpolation pixel by applying the interpolation filter to the integer pixel and by using the interpolated block including interpolated pixels as a prediction block.

The intra-prediction unit 182 predicts a current block with reference to samples neighboring the block that is now to be encoded. The intra-prediction unit 182 may perform the following procedure in order to perform intra-prediction. First, the intra-prediction unit 182 may prepare a reference sample necessary to generate a prediction signal. Furthermore, the intra-prediction unit 182 may generate a prediction signal using the prepared reference sample. Next, the intra-prediction unit 182 may encode a prediction mode. In this case, the reference sample may be prepared through reference sample padding and/or reference sample filtering. A quantization error may be present because the reference sample experiences the prediction and the reconstruction process. Accordingly, in order to reduce such an error, a reference sample filtering process may be performed on each prediction mode used for the intra-prediction.

The prediction signal (or prediction block) generated through the inter-prediction unit 181 or the intra-prediction unit 182 may be used to generate a reconstructed signal (or reconstructed block) or may be used to generate a residual signal (or residual block).

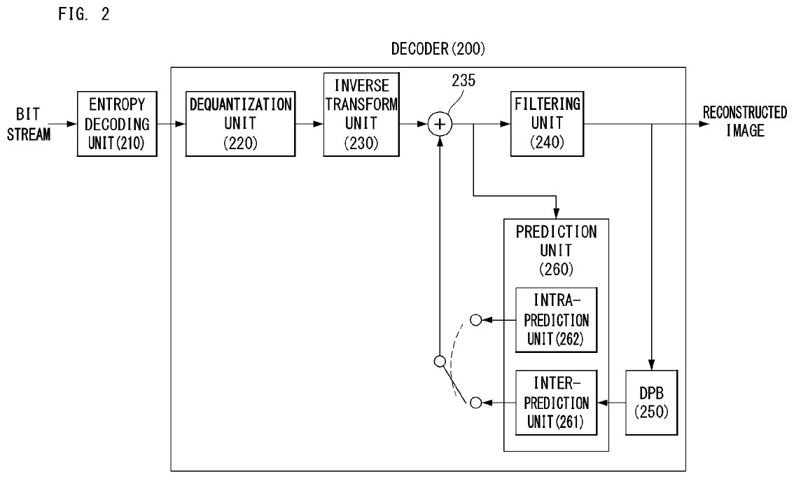

FIG. 2 illustrates a schematic block diagram of a decoder in which decoding of a still image or video signal is performed, as an embodiment to which the present disclosure is applied.

Referring to FIG. 2, the decoder 200 may include an entropy decoding unit 210, a dequantization unit 220, an inverse transform unit 230, an adder 235, a filtering unit 240, a decoded picture buffer (DPB) 250 and a prediction unit 260. Furthermore, the prediction unit 260 may include an inter-prediction unit 261 and an intra-prediction unit 262.

Furthermore, a reconstructed video signal output through the decoder 200 may be played back through a playback device.

The decoder 200 receives a signal (i.e., bit stream) output by the encoder 100 shown in FIG. 1. The entropy decoding unit 210 performs an entropy decoding operation on the received signal.

The dequantization unit 220 obtains transform coefficients from the entropy-decoded signal using quantization step size information.

The inverse transform unit 230 obtains a residual signal (or residual block) by inverse transforming the transform coefficients by applying an inverse transform scheme.

The adder 235 adds the obtained residual signal (or residual block) to the prediction signal (or prediction block) output by the prediction unit 260 (i.e., the inter-prediction unit 261 or the intra-prediction unit 262), thereby generating a reconstructed signal (or reconstructed block).

The filtering unit 240 applies filtering to the reconstructed signal (or reconstructed block) and outputs the filtered signal to a playback device or transmits the filtered signal to the decoded picture buffer 250. The filtered signal transmitted to the decoded picture buffer 250 may be used as a reference picture in the inter-prediction unit 261.

In this specification, the embodiments described in the filtering unit 160, inter-prediction unit 181 and intra-prediction unit 182 of the encoder 100 may be identically applied to the filtering unit 240, inter-prediction unit 261 and intra-prediction unit 262 of the decoder, respectively.

Processing Unit Split Structure

In general, a block-based image compression method is used in the compression technique (e.g., HEVC) of a still image or a video. The block-based image compression method is a method of processing an image by splitting it into specific block units, and may decrease memory use and a computational load.

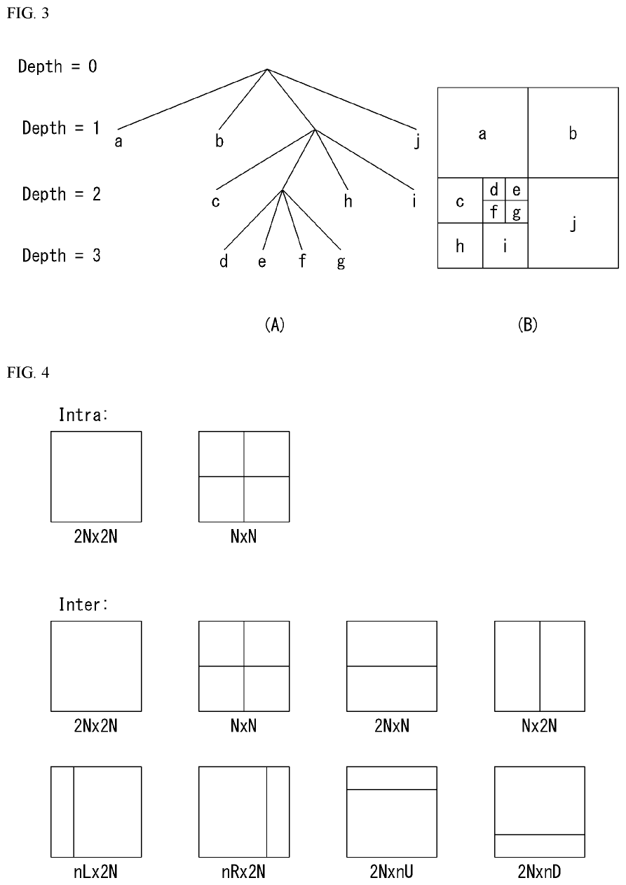

FIG. 3 is a diagram for describing a split structure of a coding unit which may be applied to the present disclosure.

An encoder splits a single image (or picture) into coding tree units (CTUs) of a quadrangle form, and sequentially encodes the CTUs one by one according to raster scan order.

In HEVC, a size of CTU may be determined as one of 64×64, 32×32, and 16×16. The encoder may select and use the size of a CTU based on resolution of an input video signal or the characteristics of input video signal. The CTU includes a coding tree block (CTB) for a luma component and the CTB for two chroma components that correspond to it.

One CTU may be split in a quad-tree structure. That is, one CTU may be split into four units each having a square form and having a half horizontal size and a half vertical size, thereby being capable of generating coding units (CUs). Such splitting of the quad-tree structure may be recursively performed. That is, the CUs are hierarchically split from one CTU in the quad-tree structure.

A CU means a basic unit for the processing process of an input video signal, for example, coding in which intra/inter prediction is performed. A CU includes a coding block (CB) for a luma component and a CB for two chroma components corresponding to the luma component. In HEVC, a CU size may be determined as one of 64×64, 32×32, 16×16, and 8×8.

Referring to FIG. 3, the root node of a quad-tree is related to a CTU. The quad-tree is split until a leaf node is reached. The leaf node corresponds to a CU.

This is described in more detail. The CTU corresponds to the root node and has the smallest depth (i.e., depth=0) value. A CTU may not be split depending on the characteristics of an input video signal. In this case, the CTU corresponds to a CU.

A CTU may be split in a quad-tree form. As a result, lower nodes, that is, a depth 1 (depth=1), are generated. Furthermore, a node (i.e., leaf node) that belongs to the lower nodes having the depth of 1 and that is no longer split corresponds to a CU. For example, in FIG. 3(b), a CU(a), a CU(b) and a CU( ) corresponding to nodes a, b and j have been once split from the CTU, and have a depth of 1.

At least one of the nodes having the depth of 1 may be split in a quad-tree form. As a result, lower nodes having a depth 1 (i.e., depth=2) are generated. Furthermore, a node (i.e., leaf node) that belongs to the lower nodes having the depth of 2 and that is no longer split corresponds to a CU. For example, in FIG. 3(b), a CU(c), a CU(h) and a CU(i) corresponding to nodes c, h and i have been twice split from the CTU, and have a depth of 2.

Furthermore, at least one of the nodes having the depth of 2 may be split in a quad-tree form again. As a result, lower nodes having a depth 3 (i.e., depth=3) are generated. Furthermore, a node (i.e., leaf node) that belongs to the lower nodes having the depth of 3 and that is no longer split corresponds to a CU. For example, in FIG. 3(b), a CU(d), a CU(e), a CU(f) and a CU(g) corresponding to nodes d, e, f and g have been three times split from the CTU, and have a depth of 3.

In the encoder, a maximum size or minimum size of a CU may be determined based on the characteristics of a video image (e.g., resolution) or by considering the encoding rate. Furthermore, information about the maximum or minimum size or information capable of deriving the information may be included in a bit stream. A CU having a maximum size is referred to as the largest coding unit (LCU), and a CU having a minimum size is referred to as the smallest coding unit (SCU).

In addition, a CU having a tree structure may be hierarchically split with predetermined maximum depth information (or maximum level information). Furthermore, each split CU may have depth information. Since the depth information represents a split count and/or degree of a CU, it may include information about the size of a CU.

Since the LCU is split in a Quad-tree shape, the size of SCU may be obtained by using a size of LCU and the maximum depth information. Or, inversely, the size of LCU may be obtained by using a size of SCU and the maximum depth information of the tree.

For a single CU, the information (e.g., a split CU flag (split_cu_flag)) that represents whether the corresponding CU is split may be forwarded to the decoder. This split information is included in all CUs except the SCU. For example, when the value of the flag that represents whether to split is ‘1’, the corresponding CU is further split into four CUs, and when the value of the flag that represents whether to split is ‘0’, the corresponding CU is not split any more, and the processing process for the corresponding CU may be performed.

As described above, a CU is a basic unit of the coding in which the intra-prediction or the inter-prediction is performed. The HEVC splits the CU in a prediction unit (PU) for coding an input video signal more effectively.

A PU is a basic unit for generating a prediction block, and even in a single CU, the prediction block may be generated in different way by a unit of PU. However, the intra-prediction and the inter-prediction are not used together for the PUs that belong to a single CU, and the PUs that belong to a single CU are coded by the same prediction method (i.e., the intra-prediction or the inter-prediction).

A PU is not split in the Quad-tree structure, but is split once in a single CU in a predetermined shape. This will be described by reference to the drawing below.

FIG. 4 is a diagram for describing a prediction unit that may be applied to the present disclosure.

A PU is differently split depending on whether the intra-prediction mode is used or the inter-prediction mode is used as the coding mode of the CU to which the PU belongs.

FIG. 4(a) illustrates a PU if the intra-prediction mode is used, and FIG. 4(b) illustrates a PU if the inter-prediction mode is used.

Referring to FIG. 4(a), assuming that the size of a single CU is 2N×2N (N=4, 8, 16 and 32), the single CU may be split into two types (i.e., 2N×2N or N×N).

In this case, if a single CU is split into the PU of 2N×2N shape, it means that only one PU is present in a single CU.

Meanwhile, if a single CU is split into the PU of N×N shape, a single CU is split into four PUs, and different prediction blocks are generated for each PU unit. However, such PU splitting may be performed only if the size of CB for the luma component of CU is the minimum size (i.e., the case that a CU is an SCU).

Referring to FIG. 4(b), assuming that the size of a single CU is 2N×2N (N=4, 8, 16 and 32), a single CU may be split into eight PU types (i.e., 2N×2N, N×N, 2N×N, N×2N, nL×2N, nR×2N, 2N×nU and 2N×nD)

As in the intra-prediction, the PU split of N×N shape may be performed only if the size of CB for the luma component of CU is the minimum size (i.e., the case that a CU is an SCU).

The inter-prediction supports the PU split in the shape of 2N×N that is split in a horizontal direction and in the shape of N×2N that is split in a vertical direction.

In addition, the inter-prediction supports the PU split in the shape of nL×2N, nR×2N, 2N×nU and 2N×nD, which is an asymmetric motion split (AMP). In this case, ‘n’ means ¼ value of 2N. However, the AMP may not be used if the CU to which the PU is belonged is the CU of minimum size.

In order to encode the input video signal in a single CTU efficiently, the optimal split structure of the coding unit (CU), the prediction unit (PU) and the transform unit (TU) may be determined based on a minimum rate-distortion value through the processing process as follows. For example, as for the optimal CU split process in a 64×64 CTU, the rate-distortion cost may be calculated through the split process from a CU of 64×64 size to a CU of 8×8 size. The detailed process is as follows.

1) The optimal split structure of a PU and TU that generates the minimum rate distortion value is determined by performing inter/intra-prediction, transformation/quantization, dequantization/inverse transformation and entropy encoding on the CU of 64×64 size.

2) The optimal split structure of a PU and TU is determined to split the 64×64 CU into four CUs of 32×32 size and to generate the minimum rate distortion value for each 32×32 CU.

3) The optimal split structure of a PU and TU is determined to further split the 32×32 CU into four CUs of 16×16 size and to generate the minimum rate distortion value for each 16×16 CU.

4) The optimal split structure of a PU and TU is determined to further split the 16×16 CU into four CUs of 8×8 size and to generate the minimum rate distortion value for each 8×8 CU.

5) The optimal split structure of a CU in the 16×16 block is determined by comparing the rate-distortion value of the 16×16 CU obtained in the process 3) with the addition of the rate-distortion value of the four 8×8 CUs obtained in the process 4). This process is also performed for remaining three 16×16 CUs in the same manner.

6) The optimal split structure of CU in the 32×32 block is determined by comparing the rate-distortion value of the 32×32 CU obtained in the process 2) with the addition of the rate-distortion value of the four 16×16 CUs that is obtained in the process 5). This process is also performed for remaining three 32×32 CUs in the same manner.

7) Finally, the optimal split structure of CU in the 64×64 block is determined by comparing the rate-distortion value of the 64×64 CU obtained in the process 1) with the addition of the rate-distortion value of the four 32×32 CUs obtained in the process 6).

In the intra-prediction mode, a prediction mode is selected as a PU unit, and prediction and reconstruction are performed on the selected prediction mode in an actual TU unit.

A TU means a basic unit in which actual prediction and reconstruction are performed. A TU includes a transform block (TB) for a luma component and a TB for two chroma components corresponding to the luma component.

In the example of FIG. 3, as in an example in which one CTU is split in the quad-tree structure to generate a CU, a TU is hierarchically split from one CU to be coded in the quad-tree structure.

TUs split from a CU may be split into smaller and lower TUs because a TU is split in the quad-tree structure. In HEVC, the size of a TU may be determined to be as one of 32×32, 16×16, 8×8 and 4×4.

Referring back to FIG. 3, the root node of a quad-tree is assumed to be related to a CU. The quad-tree is split until a leaf node is reached, and the leaf node corresponds to a TU.

This is described in more detail. A CU corresponds to a root node and has the smallest depth (i.e., depth=0) value. A CU may not be split depending on the characteristics of an input image. In this case, the CU corresponds to a TU.

A CU may be split in a quad-tree form. As a result, lower nodes having a depth 1 (depth=1) are generated. Furthermore, a node (i.e., leaf node) that belongs to the lower nodes having the depth of 1 and that is no longer split corresponds to a TU. For example, in FIG. 3(b), a TU(a), a TU(b) and a TU(j) corresponding to the nodes a, b and j are once split from a CU and have a depth of 1.

At least one of the nodes having the depth of 1 may be split in a quad-tree form again. As a result, lower nodes having a depth 2 (i.e., depth=2) are generated. Furthermore, a node (i.e., leaf node) that belongs to the lower nodes having the depth of 2 and that is no longer split corresponds to a TU. For example, in FIG. 3(b), a TU(c), a TU(h) and a TU(i) corresponding to the node c, h and l have been split twice from the CU and have the depth of 2.

Furthermore, at least one of the nodes having the depth of 2 may be split in a quad-tree form again. As a result, lower nodes having a depth 3 (i.e., depth=3) are generated. Furthermore, a node (i.e., leaf node) that belongs to the lower nodes having the depth of 3 and that is no longer split corresponds to a CU. For example, in FIG. 3(b), a TU(d), a TU(e), a TU(f) and a TU(g) corresponding to the nodes d, e, f and g have been three times split from the CU and have the depth of 3.

A TU having a tree structure may be hierarchically split with predetermined maximum depth information (or maximum level information). Furthermore, each spit TU may have depth information. The depth information may include information about the size of the TU because it indicates the split number and/or degree of the TU.

Information (e.g., a split TU flag “split_transform_flag”) indicating whether a corresponding TU has been split with respect to one TU may be transferred to the decoder. The split information is included in all of TUs other than a TU of a minimum size. For example, if the value of the flag indicating whether a TU has been split is “1”, the corresponding TU is split into four TUs. If the value of the flag indicating whether a TU has been split is “0”, the corresponding TU is no longer split.

Prediction

In order to reconstruct a current processing unit on which decoding is performed, the decoded part of a current picture or other pictures including the current processing unit may be used.

A picture (slice) using only a current picture for reconstruction, that is, on which only intra-prediction is performed, may be called an intra-picture or I picture (slice), a picture (slice) using a maximum of one motion vector and reference index in order to predict each unit may be called a predictive picture or P picture (slice), and a picture (slice) using a maximum of two motion vector and reference indices may be called a bi-predictive picture or B a picture (slice).

Intra-prediction means a prediction method of deriving a current processing block from the data element (e.g., a sample value) of the same decoded picture (or slice). That is, intra-prediction means a method of predicting the pixel value of a current processing block with reference to reconstructed regions within a current picture.

Hereinafter, inter-prediction is described in more detail.

Inter-Prediction (or Inter-Frame Prediction)

Inter-prediction means a prediction method of deriving a current processing block based on the data element (e.g., sample value or motion vector) of a picture other than a current picture. That is, inter-prediction means a method of predicting the pixel value of a current processing block with reference to reconstructed regions within another reconstructed picture other than a current picture.

Inter-prediction (or inter-picture prediction) is a technology for removing redundancy present between pictures and is chiefly performed through motion estimation and motion compensation.

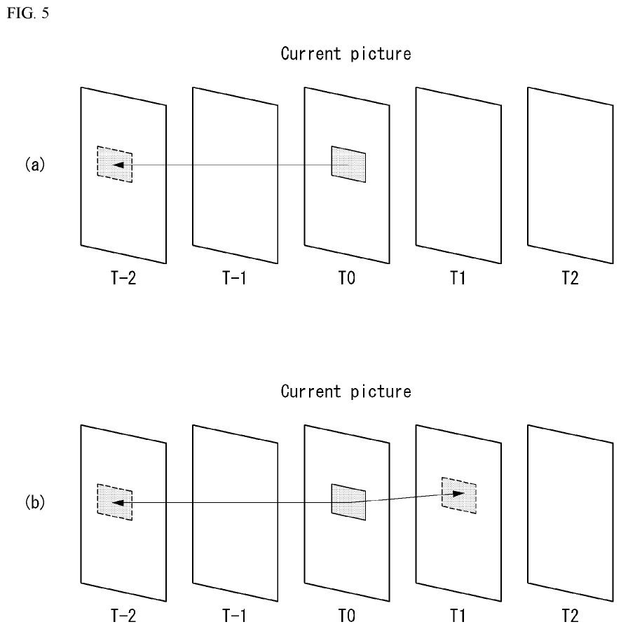

FIG. 5 is an embodiment to which the present disclosure may be applied and is a diagram illustrating the direction of inter-prediction.

Referring to FIG. 5, inter-prediction may be divided into uni-direction prediction in which only one past picture or future picture is used as a reference picture on a time axis with respect to a single block and bi-directional prediction in which both the past and future pictures are referred at the same time.

Furthermore, the uni-direction prediction may be divided into forward direction prediction in which a single reference picture temporally displayed (or output) prior to a current picture is used and backward direction prediction in which a single reference picture temporally displayed (or output) after a current picture is used.

In the inter-prediction process (i.e., uni-direction or bi-directional prediction), a motion parameter (or information) used to specify which reference region (or reference block) is used in predicting a current block includes an inter-prediction mode (in this case, the inter-prediction mode may indicate a reference direction (i.e., uni-direction or bidirectional) and a reference list (i.e., L0, L1 or bidirectional)), a reference index (or reference picture index or reference list index), and motion vector information. The motion vector information may include a motion vector, motion vector prediction (MVP) or a motion vector difference (MVD). The motion vector difference means a difference between a motion vector and a motion vector predictor.

In the uni-direction prediction, a motion parameter for one-side direction is used. That is, one motion parameter may be necessary to specify a reference region (or reference block).

In the bi-directional prediction, a motion parameter for both directions is used. In the bi-directional prediction method, a maximum of two reference regions may be used. The two reference regions may be present in the same reference picture or may be present in different pictures. That is, in the bi-directional prediction method, a maximum of two motion parameters may be used. Two motion vectors may have the same reference picture index or may have different reference picture indices. In this case, the reference pictures may be displayed temporally prior to a current picture or may be displayed (or output) temporally after a current picture.

The encoder performs motion estimation in which a reference region most similar to a current processing block is searched for in reference pictures in an inter-prediction process. Furthermore, the encoder may provide the decoder with a motion parameter for a reference region.

The encoder/decoder may obtain the reference region of a current processing block using a motion parameter. The reference region is present in a reference picture having a reference index. Furthermore, the pixel value or interpolated value of a reference region specified by a motion vector may be used as the predictor of a current processing block. That is, motion compensation in which an image of a current processing block is predicted from a previously decoded picture is performed using motion information.

In order to reduce the transfer rate related to motion vector information, a method of obtaining a motion vector predictor (mvd) using motion information of previously decoded blocks and transmitting only the corresponding difference (mvd) may be used. That is, the decoder calculates the motion vector predictor of a current processing block using motion information of other decoded blocks and obtains a motion vector value for the current processing block using a difference from the encoder. In obtaining the motion vector predictor, the decoder may obtain various motion vector candidate values using motion information of other already decoded blocks, and may obtain one of the various motion vector candidate values as a motion vector predictor.

Reference Picture Set and Reference Picture List

In order to manage multiple reference pictures, a set of previously decoded pictures are stored in the decoded picture buffer (DPB) for the decoding of the remaining pictures.

A reconstructed picture that belongs to reconstructed pictures stored in the DPB and that is used for inter-prediction is called a reference picture. In other words, a reference picture means a picture including a sample that may be used for inter-prediction in the decoding process of a next picture in a decoding order.

A reference picture set (RPS) means a set of reference pictures associated with a picture, and includes all of previously associated pictures in the decoding order. A reference picture set may be used for the inter-prediction of an associated picture or a picture following a picture in the decoding order. That is, reference pictures retained in the decoded picture buffer (DPB) may be called a reference picture set. The encoder may provide the decoder with a sequence parameter set (SPS) (i.e., a syntax structure having a syntax element) or reference picture set information in each slice header.

A reference picture list means a list of reference pictures used for the inter-prediction of a P picture (or slice) or a B picture (or slice). In this case, the reference picture list may be divided into two reference pictures lists, which may be called a reference picture list 0 (or L0) and a reference picture list 1 (or L1). Furthermore, a reference picture belonging to the reference picture list 0 may be called a reference picture 0 (or L0 reference picture), and a reference picture belonging to the reference picture list 1 may be called a reference picture 1 (or L1 reference picture).

In the decoding process of the P picture (or slice), one reference picture list (i.e., the reference picture list 0). In the decoding process of the B picture (or slice), two reference pictures lists (i.e., the reference picture list 0 and the reference picture list 1) may be used. Information for distinguishing between such reference picture lists for each reference picture may be provided to the decoder through reference picture set information. The decoder adds a reference picture to the reference picture list 0 or the reference picture list 1 based on reference picture set information.

In order to identify anyone specific reference picture within a reference picture list, a reference picture index (or reference index) is used.

Fractional Sample Interpolation

A sample of a prediction block for an inter-predicted current processing block is obtained from the sample value of a corresponding reference region within a reference picture identified by a reference picture index. In this case, a corresponding reference region within a reference picture indicates the region of a location indicated by the horizontal component and vertical component of a motion vector. Fractional sample interpolation is used to generate a prediction sample for non-integer sample coordinates except a case where a motion vector has an integer value. For example, a motion vector of ¼ scale of the distance between samples may be supported.

In the case of HEVC, fractional sample interpolation of a luma component applies an 8 tab filter in the traverse direction and longitudinal direction. Furthermore, the fractional sample interpolation of a chroma component applies a 4 tab filter in the traverse direction and the longitudinal direction.

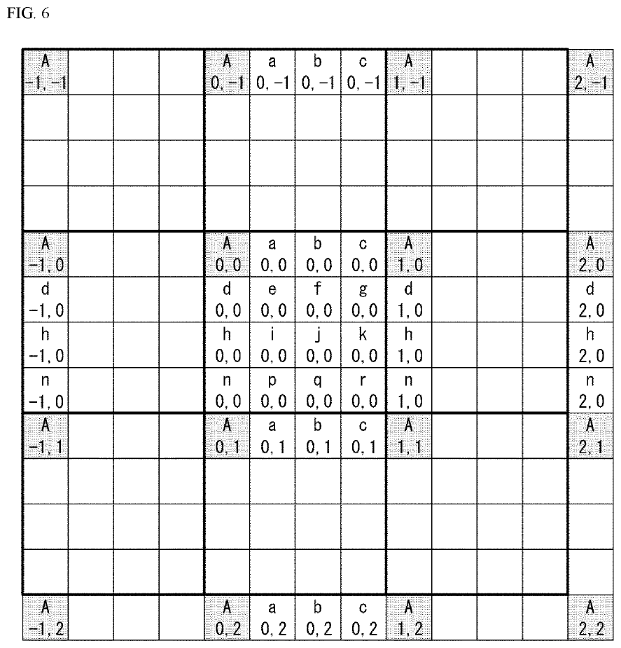

FIG. 6 is an embodiment to which the present disclosure may be applied and illustrates integers for ¼ sample interpolation and a fraction sample locations.

Referring to FIG. 6, a shadow block in which an upper-case letter (A_i,j) is written indicates an integer sample location, and a block not having a shadow in which a lower-case letter (x_i,j) is written indicates a fraction sample location.

A fraction sample is generated by applying an interpolation filter to an integer sample value in the horizontal direction and the vertical direction. For example, in the case of the horizontal direction, the 8 tab filter may be applied to four integer sample values on the left side and four integer sample values on the right side based on a fraction sample to be generated.

Inter-Prediction Mode

In HEVC, in order to reduce the amount of motion information, a merge mode and advanced motion vector prediction (AMVP) may be used.

1) Merge Mode

The merge mode means a method of deriving a motion parameter (or information) from a spatially or temporally neighbor block.

In the merge mode, a set of available candidates includes spatially neighboring candidates, temporal candidates and generated candidates.

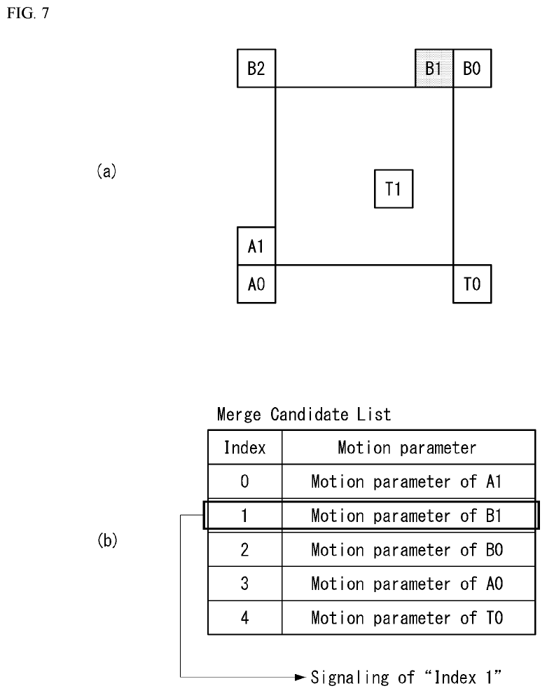

FIG. 7 is an embodiment to which the present disclosure may be applied and illustrates the location of a spatial candidate.

Referring to FIG. 7(a), whether each spatial candidate block is available depending on the sequence of {A1, B1, B0, A0, B2} is determined. In this case, if a candidate block is not encoded in the intra-prediction mode and motion information is present or if a candidate block is located out of a current picture (or slice), the corresponding candidate block cannot be used.

After the validity of a spatial candidate is determined, a spatial merge candidate may be configured by excluding an unnecessary candidate block from the candidate block of a current processing block. For example, if the candidate block of a current prediction block is a first prediction block within the same coding block, candidate blocks having the same motion information other than a corresponding candidate block may be excluded.

When the spatial merge candidate configuration is completed, a temporal merge candidate configuration process is performed in order of {T0, T1}.

In a temporal candidate configuration, if the right bottom block T0 of a collocated block of a reference picture is available, the corresponding block is configured as a temporal merge candidate. The collocated block means a block present in a location corresponding to a current processing block in a selected reference picture. In contrast, if not, a block T1 located at the center of the collocated block is configured as a temporal merge candidate.

A maximum number of merge candidates may be specified in a slice header. If the number of merge candidates is greater than the maximum number, a spatial candidate and temporal candidate having a smaller number than the maximum number are maintained. If not, the number of additional merge candidates (i.e., combined bi-predictive merging candidates) is generated by combining candidates added so far until the number of candidates becomes the maximum number.

The encoder configures a merge candidate list using the above method, and signals candidate block information, selected in a merge candidate list by performing motion estimation, to the decoder as a merge index (e.g., merge_idx[x0][y0]′). FIG. 7(b) illustrates a case where a B1 block has been selected from the merge candidate list. In this case, an “index 1 (Index 1)” may be signaled to the decoder as a merge index.

The decoder configures a merge candidate list like the encoder, and derives motion information about a current prediction block from motion information of a candidate block corresponding to a merge index from the encoder in the merge candidate list. Furthermore, the decoder generates a prediction block for a current processing block based on the derived motion information (i.e., motion compensation).

2) Advanced Motion Vector Prediction (AMVP) Mode

The AMVP mode means a method of deriving a motion vector prediction value from a neighbor block. Accordingly, a horizontal and vertical motion vector difference (MVD), a reference index and an inter-prediction mode are signaled to the decoder. Horizontal and vertical motion vector values are calculated using the derived motion vector prediction value and a motion vector difference (MVDP) provided by the encoder.

That is, the encoder configures a motion vector predictor candidate list, and signals a motion reference flag (i.e., candidate block information) (e.g., mvp_IX_flag[x0][y0]′), selected in motion vector predictor candidate list by performing motion estimation, to the decoder. The decoder configures a motion vector predictor candidate list like the encoder, and derives the motion vector predictor of a current processing block using motion information of a candidate block indicated by a motion reference flag received from the encoder in the motion vector predictor candidate list. Furthermore, the decoder obtains a motion vector value for the current processing block using the derived motion vector predictor and a motion vector difference transmitted by the encoder. Furthermore, the decoder generates a prediction block for the current processing block based on the derived motion information (i.e., motion compensation).

In the case of the AMVP mode, two spatial motion candidates of the five available candidates in FIG. 7 are selected. The first spatial motion candidate is selected from a {A0, A1} set located on the left side, and the second spatial motion candidate is selected from a {B0, B1, B2} set located at the top. In this case, if the reference index of a neighbor candidate block is not the same as a current prediction block, a motion vector is scaled.

If the number of candidates selected as a result of search for spatial motion candidates is 2, a candidate configuration is terminated. If the number of selected candidates is less than 2, a temporal motion candidate is added.

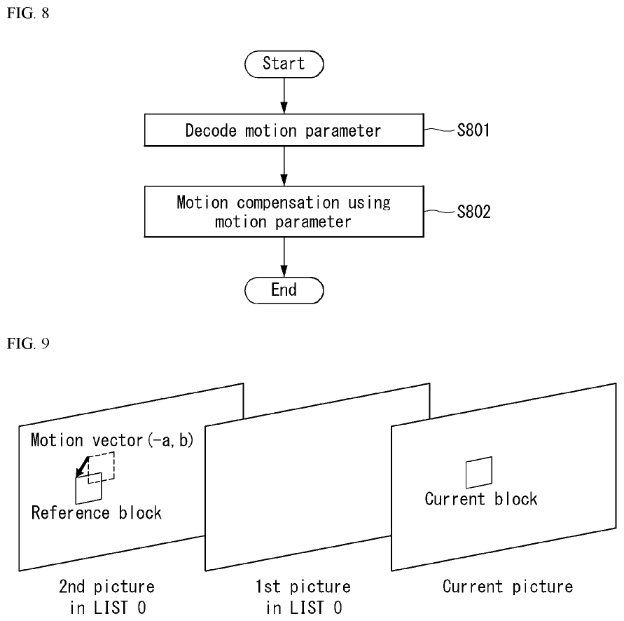

FIG. 8 is an embodiment to which the present disclosure is applied and is a diagram illustrating an inter-prediction method.

Referring to FIG. 8, the decoder (in particular, the inter-prediction unit 261 of the decoder in FIG. 2) decodes a motion parameter for a processing block (e.g., a prediction unit) (S801).

For example, if the merge mode has been applied to the processing block, the decoder may decode a merge index signaled by the encoder. Furthermore, the motion parameter of the current processing block may be derived from the motion parameter of a candidate block indicated by the merge index.

Furthermore, if the AMVP mode has been applied to the processing block, the decoder may decode a horizontal and vertical motion vector difference (MVD), a reference index and an inter-prediction mode signaled by the encoder. Furthermore, the decoder may derive a motion vector predictor from the motion parameter of a candidate block indicated by a motion reference flag, and may derive the motion vector value of a current processing block using the motion vector predictor and the received motion vector difference.

The decoder performs motion compensation on a prediction unit using the decoded motion parameter (or information) (S802).

That is, the encoder/decoder perform motion compensation in which an image of a current unit is predicted from a previously decoded picture using the decoded motion parameter.

FIG. 9 is an embodiment to which the present disclosure may be applied and is a diagram illustrating a motion compensation process.

FIG. 9 illustrates a case where a motion parameter for a current block to be encoded in a current picture is uni-direction prediction, a second picture within LIST0, LIST0, and a motion vector (−a, b).

In this case, as in FIG. 9, the current block is predicted using the values (i.e., the sample values of a reference block) of a location (−a, b) spaced apart from the current block in the second picture of LIST0.

In the case of bi-directional prediction, another reference list (e.g., LIST1), a reference index and a motion vector difference are transmitted. The decoder derives two reference blocks and predicts a current block value based on the two reference blocks.

A prediction between pictures (i.e., inter prediction) is performed as a process of searching an already coded region (or a reconstructed picture) for a region (or portion) most similar to a current block to be coded, indicating the retrieved region (or portion) as a motion vector, and coding the motion vector. A method of representing motion information including a motion vector as described above includes a method of indexing the motion information of surrounding blocks and transmitting only the index of the corresponding motion information (i.e., merge mode) and a method of additionally transmitting a motion vector difference along with the index (AMVP mode).

In this case, in the AMVP mode, a prediction direction, a reference picture index, a motion vector prediction index, or a motion vector difference is coded. If a current block is in a bidirectional prediction, coding is performed on each direction. A related syntax is the same as Table 1 below.

TABLE 1

| | |
|---|---|
| . . . [symbol] | [symbol] |
| if( slice_type == B ) [symbol] | [symbol] |
| inter_pred_idc[ x0 ][ y0 ] [symbol] | ae(v) [symbol] |
| if( inter_pred_idc[ x0 ][ y0 ] != PRED_L1 ) { [symbol] | [symbol] |
| if( num_ref_idx_I0_active_minus1 >0 ) [symbol] | [symbol] |
| ref_idx_I0[x0 ][y0 ] [symbol] | ae(v) [symbol] |
| mvd_coding(x0,y0, 0 ) [symbol] | [symbol] |
| mvp_I0_flag[x0 ][y0 ] [symbol] | ae(v) [symbol] |
| } [symbol] | [symbol] |
| if( inter_pred_idc[x0 ][ y0 ] != PRED_L0 ) { [symbol] | [symbol] |
| if( num_ref_idx_I1_active_minus1 >0 ) [symbol] | [symbol] |
| ref_idx_I1[x0 ][y0 ] [symbol] | ae(v) [symbol] |
| if( mvd_I1_zero_flag && ↓ | [symbol] |
| inter_pred_idc[ x0 ][ y0 ] == PRED_BI ) { [symbol] | |
| MvdL1[x0 ][ y0 ][ 0 ] = 0 [symbol] | [symbol] |
| MvdL1[x0 ][ y0 ][ 1 ] = 0 [symbol] | [symbol] |
| } else [symbol] | [symbol] |
| mvd_coding(x0,y0, 1 ) [symbol] | [symbol] |
| mvp_I1_flag[x0 ][y0 ] [symbol] | ae(v) [symbol] |
| } [symbol] | [symbol] |
| . . . [symbol] | [symbol] |

In Table 1, a syntax element inter_pred_idc indicates the direction (i.e., L0, L1 or Bi direction) of an inter prediction. A syntax element ref_idx_lx (in this case, x=0 or 1) means the index of a reference picture in each direction. A syntax element mvp_lx_flag (in this case, x=0 or 1) indicates the index of a candidate list for a motion vector prediction in each direction. A specific candidate may be represented using a flag like the mvp_lx_flag because one of two candidates in the candidate list is selected.

In the merge mode, the encoder configures a candidate list using the motion information of surrounding blocks, selects motion information suitable for a current block, and codes an index indicating the corresponding motion information (or candidate). A related syntax is the same as Table 2 below.

TABLE 2

| | Descriptor [symbol] |
|---|---|
| prediction_unit(x0,y0,nPbW, nPbH ) { [symbol] | [symbol] |
| . . . [symbol] | [symbol] |
| } else ( /* MODE_INTER */ [symbol] | ae(v) [symbol] |
| merge_flag[x0 ][y0 ] [symbol] | [symbol] |
| if( merge_flag[x0 ][ y0 ] ) { [symbol] | [symbol] |
| if( MaxNumMergeCand>1 ) [symbol] | ae(v) [symbol] |
| merge_idx[x0 ][ y0 ] [symbol] | [symbol] |
| } else { [symbol] | [symbol] |
| . . . [symbol] | [symbol] |

In Table 2, a syntax element merge_flag is a flag indicating whether the merge mode is applied to a current block. When the merge_flag is 1, the encoder codes merge_index and transmits it to the decoder. Like the encoder, the decoder generates a candidate list using motion information of a spatial neighbor block or a temporal neighbor block, and determines motion information applied to the current block using the merge_index using the generated candidate list.

The present disclosure proposes a method of additionally selecting or searching for a reference block based on the similarity of blocks in performing motion estimation or motion compensation.

Furthermore, the present disclosure proposes a method of performing a prediction using an additional reference block based on the similarity of blocks as well as a reference block specified by motion information.

### Embodiment 1

In an embodiment of the present disclosure, the encoder/decoder may search for or select a block having high similarity with a reference block, specified by motion information, in a reconstructed region. The accuracy of a prediction can be enhanced by additionally selecting a reference block based on the similarity of blocks and using the selected reference block for an inter prediction.

In general, a method of directly transmitting motion information (e.g., the AMVP mode) or configuring a candidate list using surrounding motion information and transmitting an index is used as a method of transmitting motion information for an inter prediction (or inter-frame prediction). In contrast, the transmission of motion information may be omitted by simplifying a motion estimation process and identically determining motion information in the encoder and the decoder.

In an embodiment of the present disclosure, as an embodiment in which the method of transmitting motion information and the method of identically performing motion estimation/compensation in the decoder in the same manner as the encoder, the encoder may code (or transmit) some of motion information. The decoder may select an additional reference block based on information received from the encoder, and may perform motion compensation.

Hereinafter, in the present disclosure, a reference block identified (or specified) by motion information received (or coded) from the encoder is referred to as an initial reference block. Furthermore, a reference block selected (or searched for or determined) in a reconstructed region based on similarity with an initial reference block is referred to as an additional reference block.

By using several reference blocks in generating an inter prediction block, a noise removal effect can be expected when a reference block and a current block have high similarity. The accuracy of a prediction can be increased and compression performance can be improved in a high-resolution or ultra-high resolution image including white noise in both of a current picture and a reference picture.

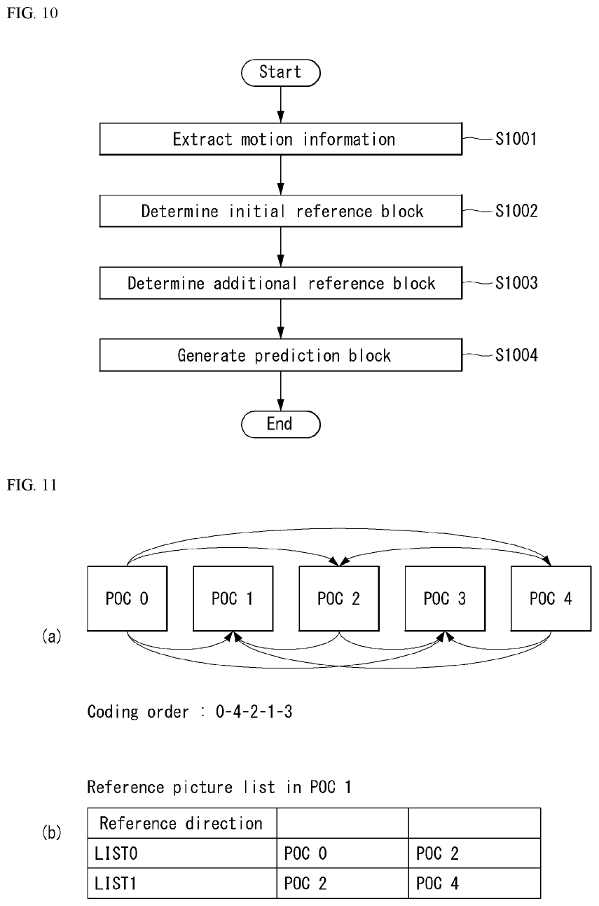

FIG. 10 is an embodiment to which the present disclosure is applied, and is a flowchart illustrating a method of additionally deriving a reference block and performing an inter prediction.

Referring to FIG. 10, for convenience of description, the decoder is basically described, but a method of performing an inter prediction using an additional reference block may be identically applied to the encoder and the decoder.

The decoder extracts motion information used for the inter prediction of a current block from a bitstream received from an encoder (S1001). The motion information may include a motion vector, an prediction mode (or a prediction direction or a reference direction) and a reference picture index.

The decoder determines an initial reference block of the current block using the motion information extracted at step S1001 (S1002). In this case, the methods described in FIGS. 5 to 9 may be applied.

The decoder determines one or more additional reference blocks within a previously reconstructed region based on the initial reference block (S1003). The decoder generates a prediction block of the current block using the initial reference block and the additional reference block (S1004). The decoder may search for or determine the additional reference block in the reconstructed region base on similarity with the initial reference block, and may generate the prediction block using the initial reference block and the additional reference block. Hereinafter, a method of determining an additional reference block is specifically described.

In an embodiment of the present disclosure, the encoder/decoder may consider (or determine) similarity between blocks in order to select an additional reference block. Motion estimation or motion compensation is a process of searching a reference picture for a block most similar to a current block. A reference block (i.e., initial reference block) determined through the process has high similarity with a current block. Accordingly, if a block having high similarity with an initial reference block is selected when an additional reference block is selected, the probability that a block having high similarity with the current block will be selected as the additional reference block is high. In this case, in order to determine similarity between the blocks, various cost functions may be used. A block having a lower value calculated using the cost function may be determined to have higher similarity.

For example, the sum of absolute differences (SAD), the sum of squared differences (SSD) or structural similarity (SSIM) may be applied as a cost function for determining similarity between blocks. The SAD indicates a value obtained by adding differences between corresponding pixel values within two blocks (or an absolute of a difference). The SSD indicates a value obtained by adding squares of differences between corresponding pixel values. The SSIM indicates a method of measuring structural similarity between blocks. The cost functions may be represented like Equation 1.

$$SAD = {\sum }_{j}^{height} {\sum }_{i}^{width} \vert {Block}_{cur} ( i , j ) - B l o c {k}_{ref} ( i , j ) \vert \\ SSD = {\sum }_{j}^{height} {\sum }_{i}^{width} {( {Block}_{cur} ( i , j ) - B l o c {k}_{ref} ( i , j ) )}^{2} \\ SSIM ( x , y ) = \frac{( 2 {μ}_{x} {μ}_{y} + {c}_{1} ) ( 2 {σ}_{x y} + {c}_{2} )}{( {μ}_{x}^{2} + {μ}_{y}^{2} + {c}_{1} ) ( {σ}_{x}^{2} + {σ}_{y}^{2} + {c}_{2} )} \qquad [ Equation 1 ]$$

Referring to Equation 1, μ indicates an average value of pixel values within a block, σ² indicates a disperse value of pixel values within a block, and σ^{xy} indicates a covariance value of two blocks. Furthermore, c indicates a coefficient for preventing a denominator from becoming excessively small, and c may be set based on a dynamic range of a block.

As described above, the encoder/decoder may select an additional reference block based on similarity between blocks. In this case, the encoder/decoder may search for the additional reference block in the same reference picture as an initial reference block, and may search for the additional reference block in another reference picture.

If the additional reference block is selected in the same reference picture, the encoder/decoder may select (or determine), as the additional reference block, a block having the highest similarity with a reference block within the same picture as the initial reference block using one of the cost functions described in Equation 1.

If the additional reference block is selected in another reference picture, the encoder/decoder may select a reference picture not including an initial reference block, and may select the additional reference block within the selected reference picture. This is described with reference the following drawing.

FIG. 11 is an embodiment to which the present disclosure is applied, and is a diagram for describing a method of determining a search region for an additional reference block.

Referring to FIG. 11, a case where the POC of a current picture is 1 and POCs 0 to 4 have a coding order of 0-4-2-1-3 is assumed.

The decoder may select a reference picture not including an initial reference block among reference pictures in a reference direction, and may search for an additional reference block. For example, when reference pictures of a current picture in the reference direction are the same as those in FIG. 11(b), if the prediction direction of the current block is a unidirectional prediction in which only LIST0 has been selected and a reference picture having a POC of 0 has been selected, the decoder may select a reference picture having a POC of 2.

Furthermore, in an embodiment of the present disclosure, the encoder/decoder may configure a search range for searching for an additional reference block by applying various methods. For example, the encoder/decoder may configure a search range by applying an unlimited search method, a motion vector scaling method, a fixed region limit method, or a variable region limit method. In this case, the unlimited search method indicates a method of searching for an additional reference block without setting a limit on a search range in order to select the additional reference. That is, if the unlimited search method is applied, the encoder/decoder may search all the regions of a reference picture for selecting an additional reference block. The motion vector scaling method is described with reference the following drawing.

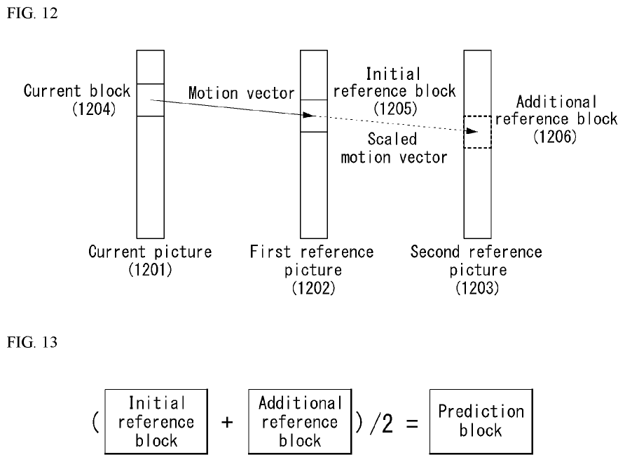

FIG. 12 is an embodiment to which the present disclosure is applied, and is a diagram for describing a method of determining a search region for an additional reference block.

Referring to FIG. 12, the encoder/decoder may project, onto a second reference picture 1203, a motion vector indicative of an initial reference block 1205, and may derive a scaled motion vector. The second reference picture 1203 indicates a reference picture (hereinafter referred to as an “additional reference picture”, for convenience of description) for selecting an additional reference block 1206.

The encoder/decoder may scale a motion vector indicative of the initial reference block 1205 based on the POC values of a current picture 1201, a first reference picture 1202 and the second reference picture 1203. Furthermore, the encoder/decoder may determine the additional reference block 1206 by calculating similarity between a block (or region) indicated by the scaled motion vector and the initial reference block 1205. Alternatively, the encoder/decoder may determine the additional reference block 1206 by comparing similarity between the initial reference block 1205 and each block (or region) neighboring to and within a specific distance (or a specific number of pixels) from a block indicated by the scaled motion vector.

Furthermore, the fixed region limit method and the variable region limit method are methods of limiting a search region for an additional reference block based on a location obtained through vector scaling, the same location as an initial reference block within an additional reference picture, etc. The fixed region limit method indicates a method of configuring a same search range in any case. The variable region limit method indicates a method of variably limiting a search region for an additional reference block by applying a quantization parameter, a slice type, a temporal ID, and a POC distance between a reference picture and a current picture.

### Embodiment 2

In an embodiment of the present disclosure, the encoder/decoder may generate a prediction block using an initial reference block and an additional reference block.

In a conventional inter prediction method, in the case of a unidirectional prediction, a reference block specified by motion information becomes a prediction block without any change. Furthermore, if a current block is in a bidirectional prediction, an average value of reference blocks in two directions becomes a prediction block.

In the present disclosure, the number of initial reference blocks and the number of additional reference blocks may be previously fixed or may not be previously fixed. If the number of initial reference blocks and the number of additional reference blocks are not fixed, the encoder/decoder may define a method of generating a prediction block in each case. In the present disclosure, a case where the number of all reference blocks including an initial reference block and an additional reference block is 2\hat{ }n and a case where the number of all reference blocks including an initial reference block and an additional reference block is not 2\hat{ }n may be considered. Hereinafter, a method of generating a prediction block when the number of all reference blocks is 2\hat{ }n is described.

FIG. 13 is an embodiment to which the present disclosure is applied, and is a diagram for describing a method of generating a prediction block using an additional reference block.

Referring to FIG. 13, a case where the inter prediction direction of a current block (or prediction mode) is a uni-direction and one additional reference block is used is assumed.

The encoder/decoder may determine an average value of an initial reference block and an additional reference block as a prediction block of a current block. Likewise, when the number of all reference blocks is 2\hat{ }n, the encoder/decoder may generate a prediction block by averaging all the reference blocks. In this case, there an advantage in that a division operation can be simply and easily implemented because the division operation can be substituted with a shift operation in a process of generating a prediction block.

Hereinafter, a method of generating a prediction block when the number of all reference blocks is not 2\hat{ }n is described below. The following method may also be applied to a case where the number of all reference blocks is 2\hat{ }n and a weight is applied to a specific reference block in addition to a case where the number of all reference blocks is not 2\hat{ }n. For example, a larger weight may be assigned to an initial reference block by considering the probability that the initial reference block specified by coded motion information will most represent a current block. This may be applied in the same manner as a case where the number of all reference blocks is not 2\hat{ }n.

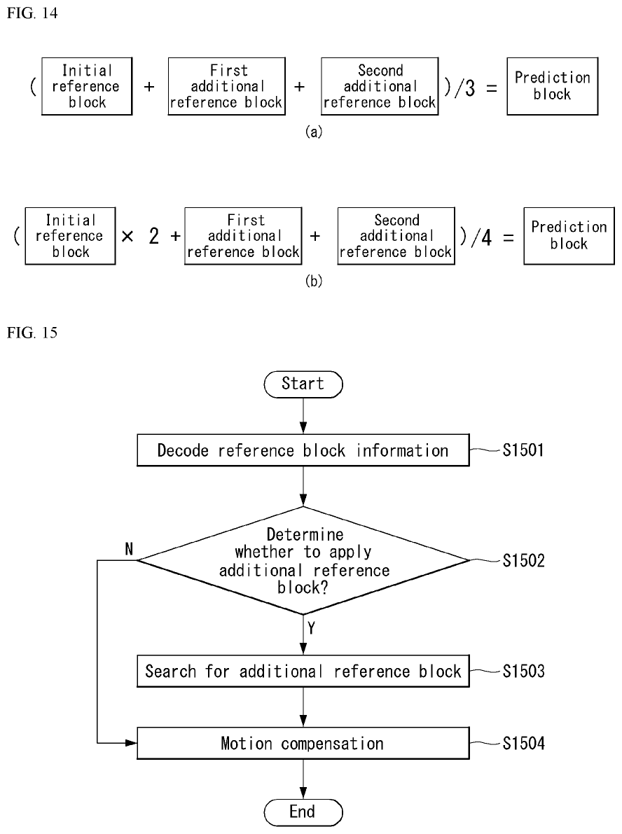

FIG. 14 is an embodiment to which the present disclosure is applied, and is a diagram for describing a method of generating a prediction block using an additional reference block.

Referring to FIG. 14, a case where the inter prediction direction of a current block (or prediction mode) is a uni-direction and two additional reference blocks are used is assumed.

The encoder/decoder may generate a prediction block by uniformly averaging all reference blocks as illustrated in FIG. 14(a), and may assign a weight to a specific reference block as illustrated in FIG. 14(b).

As in FIG. 14(a), a method of calculating an average value of each pixel of reference blocks refers to a method of dividing, by the number of reference blocks, an accumulated value of corresponding pixels of all the reference blocks. Such a method is intuitive, but may have a difficult in a hardware implementation because it includes a division operation.

As in FIG. 14(b), a method of assigning a weight refers to a method of applying a weight to an initial reference block and then calculating an average value. The encoder/decoder may simply assign (or set or calculate) a weight or may assign a weight so that a denominator for an average becomes 2\hat{ }n. If a weight is assigned so that a denominator for an average is 2\hat{ }n, there is an advantage in that a division operation can be substituted with a shift operation. That is, the encoder/decoder may set, as a value for an average, 4 that is greater than 3, that is, the number of all reference blocks, and that has the smallest 2\hat{ }n value, and may assign a weight of 2 to an initial reference block and a weight of 1 to the remaining additional reference blocks. The encoder/decoder may obtain an average value by adding values to which the weights have been applied.

Furthermore, the encoder/decoder may assign a weight to another specific reference block in addition to an initial reference block. In this case, the encoder may signal, to the decoder, information on a reference block to which a weight is assigned. Alternatively, the encoder/decoder may select a specific reference block by applying a known template matching method.

If the inter prediction direction of a current block is a bi-direction, the aforementioned method may be applied to each direction. That is, the encoder/decoder may generate a prediction block for each direction by applying the proposed method, and may determine an average value as the final prediction block.

### Embodiment 3

In an embodiment of the present disclosure, the encoder/decoder may determine whether to perform filtering on a reference block specified by motion information using an additional reference block.

FIG. 15 is an embodiment to which the present disclosure is applied, and is a flowchart illustrating an inter prediction method using an additional reference block.

Referring to FIG. 15, the decoder decodes initial reference block information (S1501). The initial reference block information may indicate motion information for identifying an initial reference block. Furthermore, the motion information may include a motion vector, an prediction mode (or a prediction direction, a reference direction) and a reference picture index. If the merge mode is applied, the motion information may be an index indicative of a specific merge candidate in a merge candidate list.

The decoder determines whether to apply an additional reference block (S1502). In other words, the decoder may determine whether to perform filtering on a reference block, specified by the motion information received from the encoder, using an additional reference block. The encoder may transmit, to the decoder, a flag indicating whether an additional reference block will be applied (i.e., on/off). Alternatively, the encoder and the decoder may determine whether to apply an additional reference block depending on whether a specific condition is satisfied.

Table 3 is an example of a syntax that determines whether to apply an additional reference block in the AMVP mode.

TABLE 3

| | |
|---|---|
| . . . [symbol] | [symbol] |
| if( slice_type == B ) [symbol] | [symbol] |
| inter_pred_idc[x0 ][ y0 ] [symbol] | ae(v) [symbol] |
| if( inter_pred_idc[x0 ][ y0 ] != PRED_L1 ) { [symbol] | [symbol] |
| if( num_ref_idx_I0_active_minus1 >0 ) [symbol] | [symbol] |
| ref_idx_I0[x0 ][y0 ] [symbol] | ae(v) [symbol] |
| mvd_coding(x0,y0, 0 ) [symbol] | [symbol] |
| mvp_I0_flag[x0 ][y0 ] [symbol] | ae(v) [symbol] |
| multiple_comp_I0[x0 ][ y0 ] [symbol] | ae(v) [symbol] |
| } [symbol] | [symbol] |
| if( inter_pred_idc[x0 ][ y0 ] != PRED_L0 ) { [symbol] | [symbol] |
| if( num_ref_idx_I1_active_minus1 >0 ) [symbol] | [symbol] |
| ref_idx_I1[x0 ][y0 ] [symbol] | ae(v) [symbol] |
| if( mvd_I1_zero_flag && ↓ | [symbol] |
| inter_pred_idc[ x0 ][ y0 ] == PRED_BI ) { [symbol] | |
| MvdL1[x0 ][ y0 ][ 0 ] = 0 [symbol] | [symbol] |
| MvdL1[x0 ][ y0 ][ 1 ] = 0 [symbol] | [symbol] |
| } else [symbol] | [symbol] |
| mvd_coding( x0,y0, 1 ) [symbol] | [symbol] |
| mvp_I1_flag[x0 ][ y0 ] [symbol] | ae(v) [symbol] |
| multiple_comp_idc[x0 ][ y0 ] [symbol] | ae(v) [symbol] |
| } [symbol] | [symbol] |
| . . . [symbol] | [symbol] |

Referring to Table 3, the encoder may signal, to the decoder, a flag indicating whether to apply an additional reference block with respect to each prediction direction. multiple_comp_l0[x0][y0] is a flag indicating whether to apply an additional reference block in the LIST 0 direction. multiple_comp_l1[x0][y0] is a flag indicating whether to apply an additional reference block in the LIST 1 direction.

Table 4 is an example of a syntax that determines whether to apply an additional reference block in the merge mode.

TABLE 4

| | Descriptor [symbol] |
|---|---|
| prediction_unit(x0,y0,nPbW, nPbH ) { [symbol] | |
| . . . [symbol] | [symbol] |
| } else ( /* MODE_INTER */ [symbol] | [symbol] |
| merge_flag[x0 ][y0 ] [symbol] | ae(v) [symbol] |
| if( merge_flag[x0 ][ y0 ] ) { [symbol] | [symbol] |
| if( MaxNumMergeCand>1 ) [symbol] | [symbol] |
| merge_idx[x0 ][ y0 ] [symbol] | ae(v) [symbol] |
| multiple_comp_idc[ x0 ][ y0 ] [symbol] | ae(v) [symbol] |
| } else { [symbol] | [symbol] |
| . . . [symbol] | [symbol] |

Referring to Table 4, multiple_comp_idc[x0][y0] is a syntax indicating whether to apply an additional reference block. In the AMVP mode, a flag may be signaled with respect to each prediction direction. In the merge mode, an index value not a flag may be signaled for selective application with respect to each direction.

In addition to the method of signaling whether to apply a reference block, the decoder may determine whether to apply a reference block depending on whether a specific condition is satisfied in the same manner as the encoder.

For example, the specific condition may include whether the region of a reference block specified (or predicted) through a motion vector method is within a reference picture, whether similarity between an initial reference block and an additional reference block exceeds a specific threshold value, etc. In this case, the threshold value may be pre-determined by the encoder and the decoder, and may be coded in a high level syntax. Alternatively, the threshold value may be coded in a picture, slice, CTU or coding unit unit or may be adaptively calculated. Furthermore, a maximum number of additional reference blocks may be fixed in all cases, or may be coded in a high level syntax and applied according to circumstances.

If, as a result of the determination at step S1502, an additional reference block is applied, the decoder searches for an additional reference block (S1503). In this case, the methods described in Embodiment 1 may be applied.

Furthermore, the decoder performs motion compensation (S1504). If an additional reference block is applied, the methods described in Embodiment 2 may be applied. If an additional reference block is not applied, a reference block specified by motion information becomes a prediction block without any change in the case of a unidirectional prediction. Furthermore, if a current block is in a bidirectional prediction, an average value of reference blocks become a prediction block in each direction.

### Embodiment 4

In an embodiment of the present disclosure, there are proposed detailed embodiments in which an additional reference block is searched for and motion compensation is performed.

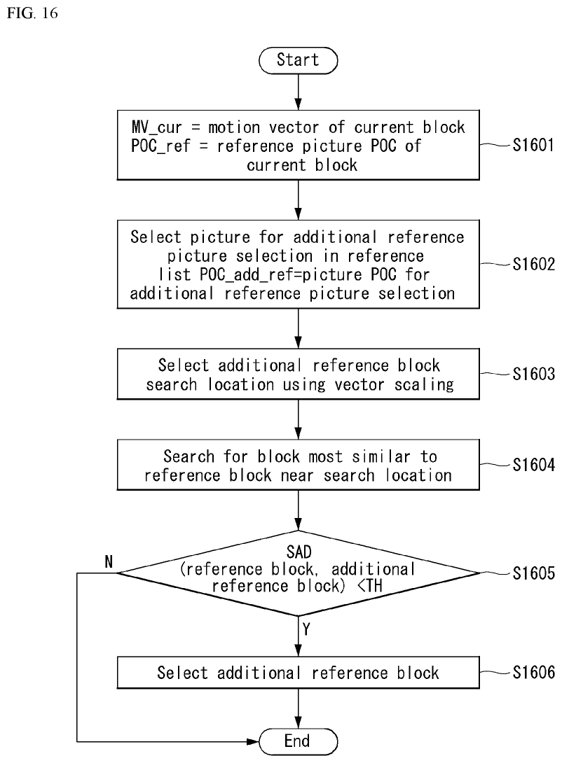

FIG. 16 is an embodiment to which the present disclosure is applied, and is a flowchart illustrating a method of selecting an additional reference block based on similarity with a reference block specified by motion information.

The encoder/decoder determines (or stores) the motion vector of a current block and the POC of a reference picture of the current block (S1601).

The encoder/decoder selects a reference picture, that is, an additional reference picture for searching for an additional reference block, in a reference picture list based on a reference direction of the current block (S1602). For example, the encoder/decoder may select a picture closest (or having the smallest POC difference) to the current picture among pictures other than a reference picture including an initial reference block. Furthermore, the encoder/decoder may select a plurality of additional reference pictures.

The encoder/decoder determines (or selects) a location for additional reference block search in the additional reference picture (S1603). In this case, the method described in FIG. 12 may be applied. In this case, Equation 2 may be applied.

$$M {V}_{scale} = \frac{( {POC}_{addref} - {POC}_{cur} )}{( {POC}_{ref} - {POC}_{cur} )} \times M V \qquad [ Equation 2 ]$$

Referring to Equation 2, a scaled motion vector may be computed using the POC of a current picture, the POC of a reference picture, and the POC of an additional reference picture. Furthermore, a round-off process may be added for the precision of an operation.

The encoder/decoder searches for a block most similar to the initial reference block around a corresponding location obtained through a scaling operation (S1604). In this case, the method described in FIG. 10 may be applied.

Furthermore, the range in which an additional reference block is searched for based on the corresponding location obtained through the scaling operation may be identically applied in the encoder and the decoder or may be transmitted as a high level syntax. For example, the encoder/decoder may configure 8 pixels as a search range based on an integer pixel.

The encoder/decoder may search for an optimal block (i.e., a block having the smallest similarity with an initial block) within the search range. In this case, for example, the encoder/decoder may calculate cost functions at locations moved by a minimum unit pixel in 8 directions, that is, top, bottom, left, right, top left, top right, bottom right and bottom left directions, with respect to a current location, and may update a location having the lowest value as a current location. Furthermore, the encoder/decoder may calculate cost functions for the 8 directions of the current location again, and may update the current location with a location whose cost function value is the lowest. In this case, the search operation may be repeated until costs calculated using the cost function converge on the lowest, and may be performed by a predetermined number. For example, the encoder/decoder performs the search operation in three steps, but may reduce a pixel unit in which the search operation is performed to a lower unit (e.g., from an integer pixel to a fractional pixel) as the step advances.

The encoder/decoder determines whether similarity between the additional reference block and the initial reference block calculated by applying the cost function is smaller than a specific threshold value, and selects, as an additional reference block, the block searched for at S1604 when the similarity is smaller than the threshold value (S1605 and S1606). That is, when the similarity is low, the encoder/decoder may not use an additional reference block. If the similarity is low, the degradation of a prediction block rather than a noise removal effect may occur. The threshold value compared to select an additional reference block may be previously fixed in the encoder and the decoder or may be transmitted in a high level syntax or may be transmitted in a picture, slice, CTU or CU unit. Alternatively, the threshold value may be variably calculated based on the size of a motion vector, the characteristics of an image, etc.

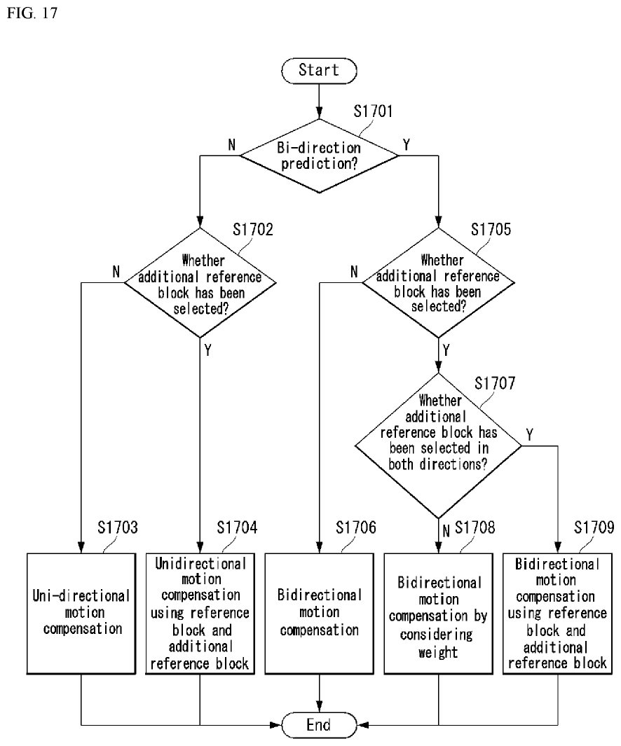

FIG. 17 is an embodiment to which the present disclosure is applied, and is a diagram illustrating a motion compensation method using an additional reference block according to an inter prediction mode.

Referring to FIG. 17, the decoder determines whether a current block is in a bidirectional prediction (S1701). If, as a result of the determination, if the current block is not in the bidirectional prediction, that is, if the current block is in a unidirectional prediction, the decoder determines whether an additional reference block is selected (S1702).

If an additional reference block is not selected, the decoder performs motion compensation using the same method as the existing method (S1703). That is, if the current block is in a unidirectional prediction, the decoder determines, as a prediction block, a reference block specified by motion information. If an additional reference block is selected, the decoder filters an initial reference block using the additional reference block and performs motion compensation (S1704). In this case, the methods described in FIGS. 10 to 16 may be applied.

If, as a result of the determination at step S1701, the current block is in the bidirectional prediction, the decoder determines whether an additional reference block is selected (S1705). If an additional reference block is not selected, the decoder performs motion compensation using the same method as the existing method (S1706). That is, if the current block is in a bidirectional prediction, the decoder averages initial reference block in both directions and determines the average as a prediction block. If an additional reference block is selected, the decoder checks whether an additional reference block has been selected in both directions (S1707). If an additional reference block has been selected in one of both the directions, the decoder performs motion compensation on the corresponding direction, averages reference blocks in all the direction, and determines the average as a prediction block (S1708). In this case, the methods described in FIGS. 10 to 16 may be applied.

If additional reference blocks have been selected in both directions, the decoder filters initial reference blocks using the additional reference blocks and performs motion compensation (S1709). In this case, the methods described in FIGS. 10 to 16 may be applied. If additional reference blocks have been selected in both the directions, likewise, the decoder may perform motion compensation using a reference block and the additional reference block in each direction, may average reference blocks in all the directions, and may determine the average as a prediction block.

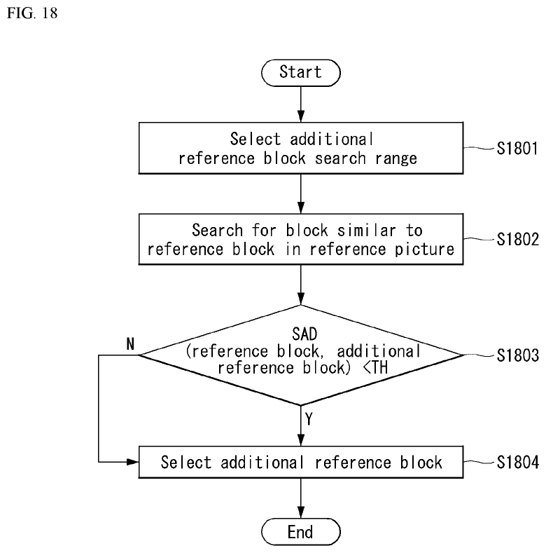

FIG. 18 is an embodiment to which the present disclosure is applied, and is a flowchart illustrating a method of selecting an additional reference block based on similarity with a reference block specified by motion information.

Referring to FIG. 18, the encoder/decoder may search for an additional reference block within a reference picture of a current block.

The encoder/decoder configures (or selects) a search range for searching for an additional reference block (S1801). If the searching for an additional reference block is performed within a same picture, a process of searching for a block having similarity may have great complexity because it is difficult to predict a search region. Accordingly, such a problem can be improved by configuring a search range for searching for an additional reference block. The search region may be configured in a CTU unit near the location of a reference block by considering complexity, or a region of a specific form may be configured. This is described with reference to the following drawing, for example.

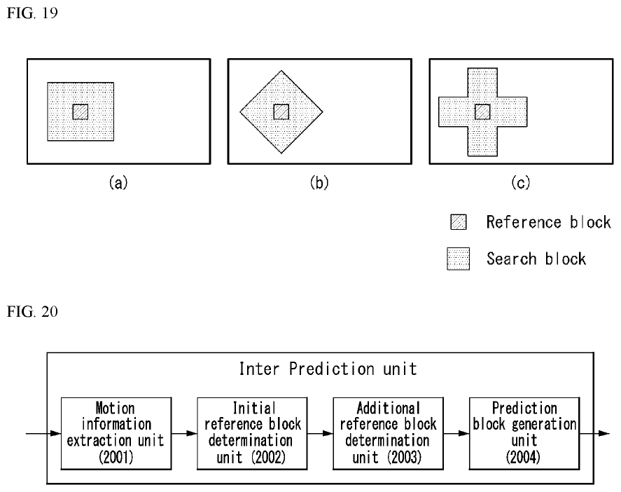

FIG. 19 is an embodiment to which the present disclosure is applied, and is a diagram illustrating an example of a method of configuring a search region for an additional reference block.

As illustrated in FIG. 19, the encoder/decoder may configure a region of a specific form as a search region based on a reference block. Specifically, as illustrated in FIG. 19(a), the encoder/decoder may configure, as a search region, 8 directions, that is, top, bottom, left, right, top left, top right, bottom right and bottom left directions. Alternatively, as illustrated in FIG. 19(b), the encoder/decoder may configure a search region in a diamond form based on a reference block. Alternatively, as illustrated in FIG. 19(c), the encoder/decoder may configure four directions of top, bottom, left and right directions as a search region.

Alternatively, the encoder/decoder may configure a search region based on the characteristics of a reference block or the direction of an edge within a reference block.

Referring back to FIG. 18, the encoder/decoder searches for a block having high similarity with an initial reference block within the search range configured at step S1801 (S1802).

The encoder/decoder determines whether similarity between blocks calculated through a cost function is smaller than a specific threshold value (S1803). When the similarity between blocks calculated through the cost function is smaller than the specific threshold value, the encoder/decoder selects, as an additional reference block, the block selected at step S1802 (S1804). Thereafter, the encoder/decoder may perform motion compensation by applying the methods described in FIGS. 10 to 17.

As described above, the encoder/decoder may configure a search region in order to search for a block most similar to a reference block within a reference picture, may search for the block, and may search for a block similar to a current block by applying a computer vision algorithm, such as a feature extraction algorithm. If the computer vision algorithm is applied, there is an advantage in that high accuracy can be expected.

FIG. 20 is a diagram illustrating an inter-prediction unit according to an embodiment of the present disclosure.

FIG. 20 illustrates the inter-prediction unit 181 (refer to FIG. 1); 261 (refer to FIG. 2) as a single block, for convenience of description, but the inter-prediction unit 181, 261 may be implemented as an element included in the encoder and/or the decoder.

Referring to FIG. 20, the inter-prediction unit 181, 261 implements the functions, processes and/or methods proposed in FIGS. 5 to 19. Specifically, the inter-prediction unit 181, 261 may be configured to include a motion information extraction unit 2001, an initial reference block determination unit 2002, an additional reference block determination unit 2003, and a prediction block generation unit 2004.

The motion information extraction unit 2001 extracts motion information used for the inter prediction of a current block from a bitstream received from the encoder. The motion information may include a motion vector, a prediction mode (or a prediction direction, a reference direction) and a reference picture index.

The initial reference block determination unit 2002 determines an initial reference block of the current block using the motion information. In this case, the methods described in FIGS. 5 to 9 may be applied.

The additional reference block determination unit 2003 determines one or more additional reference blocks within a previously reconstructed region based on the initial reference block.

The additional reference block determination unit 2003 may search for or determine an additional reference block in the previously reconstructed region by applying the methods described in FIGS. 10 to 12, 15 to 19. The additional reference block determination unit 2003 may search for one or more additional reference blocks in the previously reconstructed region. In this case, as described above, the SAD, SSD or SSIM may be applied as a cost function for determining similarity between blocks.

Furthermore, as described above, the additional reference block determination unit 2003 may search for an additional reference block in the same reference picture as the initial reference block, and may search for an additional reference block in another reference picture.

If an additional reference block is searched for in another reference picture, the additional reference block determination unit 2003 may select a reference picture, not including an initial reference block, among reference pictures in the prediction direction of a current picture, and may determine an additional reference block in the selected reference picture. In this case, the additional reference block determination unit 2003 may determine, as a reference picture for searching for or determining the additional reference block, a reference picture having a picture order count (POC) distance closest to the current picture among the reference pictures in the prediction direction of the current picture.

Furthermore, as described in FIG. 12, the additional reference block determination unit 2003 may scale the motion vector of the current block using a POC value of the current picture, a POC value of the reference picture including the initial reference block, and a POC value of the selected reference picture. Furthermore, the additional reference block determination unit 2003 may determine one or more additional reference blocks within a region specified by the scaled motion vector or a region neighboring a region specified by the scaled motion vector.

The prediction block generation unit 2004 generates a prediction block of the current block using the initial reference block and the one or more additional reference blocks. In this case, the prediction block generation unit 2004 may apply the method described in Embodiment 2.

In the aforementioned embodiments, the elements and characteristics of the present disclosure have been combined in a specific form. Each of the elements or characteristics may be considered to be optional unless otherwise described explicitly. Each of the elements or characteristics may be implemented in a form to be not combined with other elements or characteristics. Furthermore, some of the elements or the characteristics may be combined to form an embodiment of the present disclosure. The sequence of the operations described in the embodiments of the present disclosure may be changed. Some of the elements or characteristics of an embodiment may be included in another embodiment or may be replaced with corresponding elements or characteristics of another embodiment. It is evident that an embodiment may be constructed by combining claims not having an explicit citation relation in the claims or may be included as a new claim by amendments after filing an application.

The embodiment according to the present disclosure may be implemented by various means, for example, hardware, firmware, software or a combination of them. In the case of an implementation by hardware, the embodiment of the present disclosure may be implemented using one or more application-specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, etc.

In the case of an implementation by firmware or software, the embodiment of the present disclosure may be implemented in the form of a module, procedure or function for performing the aforementioned functions or operations. Software code may be stored in the memory and driven by the processor. The memory may be located inside or outside the processor and may exchange data with the processor through a variety of known means.

It is evident to those skilled in the art that the present disclosure may be materialized in other specific forms without departing from the essential characteristics of the present disclosure. Accordingly, the detailed description should not be construed as being limitative from all aspects, but should be construed as being illustrative. The scope of the present disclosure should be determined by reasonable analysis of the attached claims, and all changes within the equivalent range of the present disclosure are included in the scope of the present disclosure.

### INDUSTRIAL APPLICABILITY

The aforementioned preferred embodiments of the present disclosure have been disclosed for illustrative purposes, and those skilled in the art may improve, change, substitute, or add various other embodiments without departing from the technical spirit and scope of the present disclosure disclosed in the attached claims.

1. A method of processing an image based on an inter prediction mode, the method comprising:
extracting first motion information used for an inter prediction of a current block;
determining second motion information indicating one or more additional reference blocks which minimize a value calculated by adding absolute values of differences between corresponding pixels within previously reconstructed regions including an initial reference block of the current block indicated by the first motion information; and
generating a prediction block of the current block using the first motion information and/or the second motion information.

2. The method of claim 1,
wherein determining the second motion information includes searching the previously reconstructed regions for the one or more additional reference blocks using the value from the initial reference block.

3. (canceled)

4. The method of claim 1,
wherein determining the second motion information further includes selecting a first reference picture, not including the initial reference block
for the one or more additional reference blocks.

5. The method of claim 4,
wherein the one or more additional reference blocks are searched for within a reference picture, having a closest picture order count (POC) distance from a current picture.

6. The method of claim 4,
wherein determining the second motion information includes scaling a motion vector of the current block using a POC value of a current picture, a POC value of a reference picture including the initial reference block, and a POC value of the first reference picture, and
wherein the one or more additional reference blocks are searched for within a region specified by the scaled motion vector or a region neighboring the region specified by the scaled motion vector.

7. The method of claim 2,
wherein searching for the one or more additional reference blocks includes configuring a search region within a reference picture of a current picture, and
wherein the one or more additional reference blocks are searched for within the search region.

8. The method of claim 7,
wherein the search region is configured as a region of a specific form based on the initial reference block.

9. The method of claim 1,
wherein generating the prediction block of the current block includes generating the prediction block of the current block by averaging the initial reference block and the one or more additional reference blocks.

10. The method of claim 9,
wherein generating the prediction block of the current block includes generating the prediction block of the current block by applying a weight to the initial reference block.

11. An apparatus for processing an image based on an inter prediction mode, the apparatus comprising:
a processor configured to:
to extract first motion information used for an inter prediction of a current block;
determine second motion information indicating one or more additional reference blocks which minimize a value calculated by adding absolute values of differences between corresponding pixels within previously reconstructed regions including an initial reference block of the current block indicated by the first motion information; and
a prediction block generation unit configured to generate a prediction block of the current block using the first motion information and/or the second motion information.

12. The method of claim 1,
wherein determining the second motion information includes:
obtaining a flag representing whether to apply the second motion information; and
searching the previously reconstructed regions for the one or more additional reference blocks depending on the flag.
